(19) United States
(12) Patent Application Publication
(10) Pub. No.: US 2025/0023682 A1
(43) Pub. Date: Jan. 16, 2025

(54) METHOD FOR GENERATING AND TRANSMITTING SYNCHRONOUS SIGNAL BLOCK IN NON-TERRESTRIAL NETWORK, AND DEVICE THEREFOR

(71) Applicant: ELECTRONICS AND TELECOMMUNICATIONS RESEARCH INSTITUTE, Daejeon (KR)

(72) Inventors: Gyeong Rae IM, Daejeon (KR); Jung Bin KIM, Daejeon (KR); Pan Soo KIM, Daejeon (KR); Min Su SHIN, Daejeon (KR); In Ki LEE, Daejeon (KR); Dong Hyun JUNG, Daejeon (KR); Soo Yeob JUNG, Daejeon (KR); Seung Keun PARK, Daejeon (KR); Joon Gyu RYU, Daejeon (KR)

(73) Assignee: ELECTRONICS AND TELECOMMUNICATIONS RESEARCH INSTITUTE, Daejeon (KR)

(21) Appl. No.: 18/712,693

(22) PCT Filed: Nov. 23, 2022
(86) PCT No.: PCT/KR2022/018610

§ 371 Date: May 22, 2024

(30) Foreign Application Priority Data
Nov. 24, 2021 (KR) 10-2021-0163695

(51) Int. Cl. H04L 5/00; H04B 7/06; H04W 24/10

(52) U.S. Cl. CPC H04L 5/0048; H04B 7/0695; H04W 24/10

(57) ABSTRACT

The present invention relates to a method for transmitting a synchronization signal block (SSB) through a plurality of satellites from a base station that can connect to a plurality of gateways, wherein the method may comprise the steps of: controlling transmission of first SSBs corresponding to the number of beams of each satellite through respective transmission beams in a first SSB cycle; determining a transmission beam of each of the satellites on the basis of a first measurement report for the respective beams received from a terminal; and controlling transmission of second SSBs for determining one combination including two or more gateways among the plurality of gateways in a second SSB cycle.

### TECHNICAL FIELD

The present disclosure relates to a technique for generating and transmitting synchronization signal blocks in a communication system, and more particularly, to a technique for generating and transmitting synchronization signal blocks in a non-terrestrial network.

### BACKGROUND ART

In an environment in which a plurality of gateways (GWs) configure links with geostationary orbit satellites, each GW connected to a base station (gNB) may act like an antenna of the gNB. It is assumed that the gNB can select one of these GWs and use it as an antenna. In a scenario where there are two transmit antennas and two receive antennas which may be GWs on the ground, and there are two geostationary satellites between them, the University of Munich in Germany measured changes in channel capacity while adjusting a distance between the two receive antennas, and published a result of the measured changes. According to the result, when the distance between the receive antennas is changed, a reception phase between the satellite and the receive antenna is changed. This may change elements of a channel matrix respectively, and thus the channel capacity may change.

### DISCLOSURE

### Technical Problem

The present disclosure is directed to providing a structure of synchronization signal blocks (SSBs) for a terminal to measure a satellite channel in an environment where a plurality of gateways (GWs) and a plurality of satellites exist.

In addition, the present disclosure is directed to providing a method and an apparatus for measuring a satellite channel in an environment where a plurality of GWs and a plurality of satellites exist.

In addition, the present disclosure is directed to providing a method and an apparatus for configuring SSBs in an environment where a plurality of GWs and a plurality of satellites exist.

In addition, the present disclosure is directed to providing a method and an apparatus for determining a combination of beams and GWs based on a result of channel measurement using SSBs in an environment where a plurality of GWs and a plurality of satellites exist.

In addition, the present disclosure is directed to providing a method and an apparatus for determining a combination of beams and GWs in an environment where a plurality of GWs and a plurality of satellites exist, so that the maximum channel capacity is achieved.

### Technical Solution

A method according to an exemplary embodiment of the present disclosure for achieving the above-described objective may comprise, as a method for a base station connectable to a plurality of gateways to transmit synchronization signal blocks (SSBs) through a plurality of satellites, controlling first SSBs corresponding to a number of beams of each of the satellites to be transmitted through respective transmission beams in a first SSB period; determining a transmission beam of each of the satellites based on a first measurement report for the respective transmission beams, the first measurement report being received from a terminal; controlling second SSBs for determining one combination among combinations each including two or more gateways among the plurality of gateways to be transmitted in a second SSB period; and determining a first combination including two or more gateways based on a second measurement report for the second SSBs, the second measurement report being received from the terminal, wherein the number of the second SSBs is determined according to a number of the combinations of the gateways.

The first SSBs may be transmitted through all bandwidth parts (BWPs) of the satellites.

One BWP may be determined when determining the transmission beam of each of the satellites.

The first measurement report may include information on received signal strength(s) for at least one beam in at least one BWP.

Each of the second SSBs may be generated based on a combination of at least two gateways.

The method may further comprise, when each of the second SSBs is generated based on a combination of a first gateway and a second gateway, controlling the first gateway to transmit a first gateway SSB signal to the terminal through the plurality of satellites, the first gateway SSB signal including a primary synchronization signal (PSS), a secondary synchronization signal (SSS), a physical broadcast channel (PBCH), and at least part of a PBCH demodulation reference signal (DMRS) for demodulation of the PBCH; and controlling the second gateway to transmit a second gateway SSB signal to the terminal through the plurality of satellites, the second gateway SSB signal including a remaining part of the PBCH DMRS for demodulation of the PBCH.

The second measurement report may include channel estimation information for the first gateway and channel estimation information for the second gateway.

The at least part of the PBCH DMRS included in the first gateway SSB signal may be transmitted as being multiplied with an orthogonal Walsh code [1 1], and the remaining part of the PBCH DMRS included in the second gateway SSB signal may be transmitted as being multiplied with an orthogonal Walsh code [1 −1].

When determining the first combination, a combination having a largest antenna channel capacity may be determined as the first combination based on the received second measurement report.

A base station according to an exemplary embodiment of the present disclosure for achieving the above-described objective may comprise: a processor; and a transceiver configured to transmit or receive signals to or from a plurality of satellites through a plurality of gateways. The processor may be configured to: control first SSBs corresponding to a number of beams of each of the satellites to be transmitted through respective transmission beams in a first SSB period; determine a transmission beam of each of the satellites based on a first measurement report for the respective transmission beams, the first measurement report being received from a terminal; control second SSBs for determining one combination including two or more gateways among the plurality of gateways to be transmitted in a second SSB period; and determine a first combination including two or more gateways based on a second measurement report for the second SSBs, the second measurement report being received from the terminal, wherein the number of the second SSBs is determined according to a number of combinations of the gateways.

The processor may be further configured to control the first SSBs to be transmitted through all bandwidth parts (BWPs) of the satellites.

The processor may be further configured to determine one BWP when determining the transmission beam of each of the satellites.

The first measurement report may include information on received signal strength(s) for at least one beam in at least one BWP.

Each of the second SSBs may be generated based on a combination of at least two gateways.

When each of the second SSBs is generated based on a combination of a first gateway and a second gateway, the processor may be further configured to: control the first gateway to transmit a first gateway SSB signal to the terminal through the plurality of satellites, the first gateway SSB signal including a primary synchronization signal (PSS), a secondary synchronization signal (SSS), a physical broadcast channel (PBCH), and at least part of a PBCH demodulation reference signal (DMRS) for demodulation of the PBCH; and control the second gateway to transmit a second gateway SSB signal to the terminal through the plurality of satellites, the second gateway SSB signal including a remaining part of the PBCH DMRS for demodulation of the PBCH.

The second measurement report may include channel estimation information for the first gateway and channel estimation information for the second gateway.

The processor may be further configured to transmit the at least part of the PBCH DMRS included in the first gateway SSB signal as being multiplied with an orthogonal Walsh code [1 1], and transmit the remaining part of the PBCH DMRS included in the second gateway SSB signal as being multiplied with an orthogonal Walsh code [1 −1].

When determining the first combination, the processor may be further configured to determine a combination having a largest antenna channel capacity as the first combination based on the received second measurement report.

A method according to an exemplary embodiment of the present disclosure for achieving the above-described objective may comprise, as a method for a base station in a non-terrestrial network (NTN) to configure synchronization signal blocks (SSBs), generating first SSBs corresponding to a number of beams of each of satellites in a first SSB period; and generating second SSBs for determining one combination among combinations each including two gateways among a plurality of gateways in a second SSB period, wherein a number of the second SSBs is determined according to a number of the combinations of the gateways.

Each of the second SSBs may be configured to include a primary synchronization signal (PSS), a secondary synchronization signal (SSS), a physical broadcast channel (PBCH), and at least part of a PBCH demodulation reference signal (DMRS) for demodulation of the PBCH, which are transmitted from one gateway included in the combinations, and include a remaining part of the PBCH DMRS for demodulation of the PBCH, which is transmitted from another gateway included in the combinations.

### Advantageous Effects

According to an exemplary embodiment of the present disclosure, an SSB structure for an NTN environment in which multiple satellites and multiple gateways exist is designed so that a terminal can access the multiple gateways and the multiple satellites to maximize channel capacity. Therefore, the efficiency of radio resources can be maximized by using the SSB structure according to the present disclosure.

### DESCRIPTION OF DRAWINGS

FIG. 1A is an exemplary diagram of a channel capacity measurement environment of a Line of Sight (LOS) Multiple-Input Multiple-Output (MIMO) channel, which was used by the University of Munich in Germany.

FIG. 1B is an exemplary diagram of a result graph obtained by measuring a change in channel capacity according to movement of receive antenna(s).

FIG. 2A is an exemplary diagram of a system model for detecting a change in channel capacity according to a distance between receive antennas, which was used by the University of South Australia.

FIG. 2B is an exemplary diagram of a graph of the change in channel capacity according to the distance between the first and second terminal antennas in the exemplary structure of FIG. 2A.

FIG. 3 is an exemplary diagram of an NTN system model with multiple gateways and multiple satellites.

FIG. 4A is a graph of a change in spectral efficiency when the terminal has one antenna and the distance between the GWs is changed up to 10 m.

FIG. 4B is a graph of a change in spectral efficiency when the terminal has one antenna and the distance between the GWs is changed up to 2.2 m.

FIG. 5 is a graph of a change in channel capacity according to a change in location of the terminal from the first GW.

FIG. 6A is a graph of a change in spectral efficiency when the terminal has two receiving antennas and the distance between the GWs is changed up to 10 m.

FIG. 6B is a graph of a change in spectral efficiency when the terminal has two receiving antennas and the distance between the GWs is changed up to 2.7 m.

FIG. 7 is an exemplary diagram of a configuration of an NTN network supporting multiple GWs, multiple satellites, and multiple beams.

FIG. 8 is an exemplary diagram for describing SSB transmission for an NTN system supporting multiple GWs, multiple satellites, and multiple beams according to the present disclosure.

FIG. 9 is an exemplary diagram illustrating a structure of an SSB transmitted from each GW when there are two selected GWs according to an exemplary embodiment of the present disclosure.

FIG. 10 is an exemplary diagram for describing SSB transmission for an NTN system supporting multiple GWs, multiple satellites, and multiple beam bandwidths according to another embodiment exemplary of the present disclosure.

FIG. 11 is a block diagram illustrating an exemplary embodiment of a communication node.

### MODE FOR INVENTION

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

A communication system to which exemplary embodiments according to the present disclosure are applied will be described. The communication system to which the exemplary embodiments according to the present disclosure are applied is not limited to the contents described below, and the exemplary embodiments according to the present disclosure may be applied to various communication systems. Here, the communication system may have the same meaning as a communication network.

Throughout the present disclosure, a network may include, for example, a wireless Internet such as wireless fidelity (WiFi), mobile Internet such as a wireless broadband Internet (WiBro) or a world interoperability for microwave access (WiMax), 2G mobile communication network such as a global system for mobile communication (GSM) or a code division multiple access (CDMA), 3G mobile communication network such as a wideband code division multiple access (WCDMA) or a CDMA2000, 3.5G mobile communication network such as a high speed downlink packet access (HSDPA) or a high speed uplink packet access (HSUPA), 4G mobile communication network such as a long term evolution (LTE) network or an LTE-Advanced network, 5G mobile communication network, or the like.

Throughout the present disclosure, a terminal may refer to a mobile station, mobile terminal, subscriber station, portable subscriber station, user equipment, access terminal, or the like, and may include all or a part of functions of the terminal, mobile station, mobile terminal, subscriber station, mobile subscriber station, user equipment, access terminal, or the like.

Here, a desktop computer, laptop computer, tablet PC, wireless phone, mobile phone, smart phone, smart watch, smart glass, e-book reader, portable multimedia player (PMP), portable game console, navigation device, digital camera, digital multimedia broadcasting (DMB) player, digital audio recorder, digital audio player, digital picture recorder, digital picture player, digital video recorder, digital video player, or the like having communication capability may be used as the terminal.

Throughout the present disclosure, the base station may refer to an access point, radio access station, node B (NB), evolved node B (eNB), base transceiver station, mobile multihop relay (MMR)-BS, or the like, and may include all or part of functions of the base station, access point, radio access station, NB, eNB, base transceiver station, MMR-BS, or the like.

Hereinafter, preferred exemplary embodiments of the present disclosure will be described in more detail with reference to the accompanying drawings. In describing the present disclosure, in order to facilitate an overall understanding, the same reference numerals are used for the same elements in the drawings, and duplicate descriptions for the same elements are omitted.

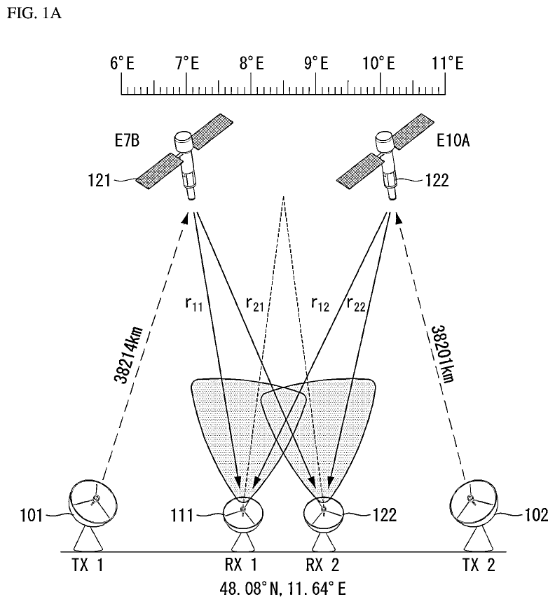

FIG. 1A is an exemplary diagram of a channel capacity measurement environment of a Line of Sight (LOS) Multiple-Input Multiple-Output (MIMO) channel, which was used by the University of Munich in Germany.

Referring to FIG. 1A, two different transmit antennas 101 and 102, two different receive antennas 111 and 112, and geostationary satellites 121 and 122 are illustrated. The two transmit antennas 101 and 102 configure single-input single-output (SISO) channels with the two satellites 121 and 122, respectively. On the other hand, the receive antennas have a wide reception beam width, so that all signals transmitted from the two satellites 121 and 122 can be received at the receive antennas. Through this, a multi-input multi-output (MIMO) channel may be formed between the two satellites 121 and 122 and each of the two receive antennas 111 and 112.

Here, when a distance between the receive antennas 111 and 112 is changed, a change in a reception phase between the satellite and the receive antenna may occur. For example, when the first receive antenna 111 is moved to the side of the first transmit antenna 101, a phase change between the first satellite 121 and the first receive antenna 111 and a phase change between the second satellite 122 and the first receive antenna 111 may occur. Due to such the phase changes, elements of a channel matrix between the first satellite 121 and the first receive antenna 111 and elements of a channel matrix between the second satellite 122 and the first receive antenna 111 may be changed. The change of channel matrix elements may mean a change in channel capacity.

FIG. 1B is an exemplary diagram of a result graph obtained by measuring a change in channel capacity according to movement of receive antenna(s).

Referring to FIG. 1B, illustrated are graphs 131 and 132 in which channel capacity is estimated and a graph 133 of a change in channel capacity based on simulation. According to FIG. 1B, it can be seen that all of the estimated graphs 131 and 132 and the simulated graph 133 show substantially the same channel capacity according to the distance between the receive antennas. That is, as shown in FIG. 1B, it can be seen that the channel capacity varies from a maximum of about 9 bps/Hz to a minimum of about 5.5 bps/Hz according to the distance between the two receive antennas 111 and 112. In addition, it can be seen that the change is repeated with periodicity as the distance d between the receive antennas increases.

Meanwhile, similar results were also published by the University of South Australia.

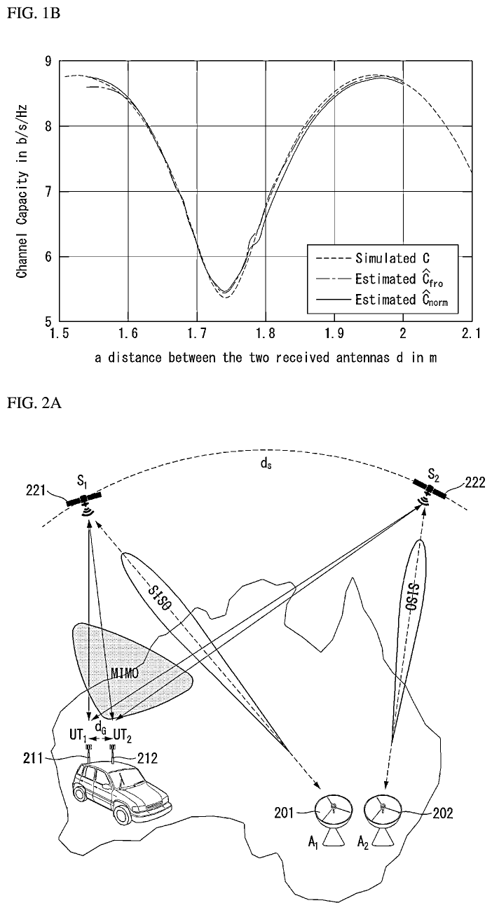

FIG. 2A is an exemplary diagram of a system model for detecting a change in channel capacity according to a distance between receive antennas, which was used by the University of South Australia.

Referring to FIG. 2A, two terrestrial stations antennas A1 and A2 (i.e., 201 and 202) located in a specific region of Australia, two satellites 221 and 222 over Australia, and two terminal antennas UT₁ and UT₂ (i.e., 211 and 212) located in a region different from that of the two terrestrial station antennas 201 and 202.

A SISO channel may be formed between the first terrestrial station antenna 201 and the first satellite 221, and a SISO channel may also be formed between the second terrestrial station antenna 202 and the second satellite 222. In addition, the first terminal antenna 211 may form a MIMO channel with the first satellite 211 and the second satellite 222, and the second terminal antenna 212 may also form a MIMO channel with the first satellite 211 and the second satellite 222. As described with reference to FIGS. 1A and 1B, it has been described that a MIMO channel matrix may change when a distance between the terminal antennas is adjusted, and thus a channel capacity thereof may change. In addition, channel capacities for a forward link, that is, a link A2U from the terrestrial station antenna A₁ or A₂ to the terminal antenna UT₁ or UT₂, and a reverse link, that is, a link U2A from the terminal antenna UT₁ or UT₂ to the terrestrial station antenna A₁ or A₂ may also change. In the case of using the configuration according to FIG. 2A, the change in channel capacity according to the distance between the antennas will be described with reference to FIG. 2B.

FIG. 2B is an exemplary diagram of a graph of the change in channel capacity according to the distance between the first and second terminal antennas in the exemplary structure of FIG. 2A.

Referring to FIG. 2B, it can be seen that in the case of SISO, constant channel capacity is maintained regardless of the distance between the antennas. However, in the case of MIMO, it can be seen that the channel capacity may vary according to the distance de between the antennas. In FIG. 2B, the link (or channel) from the terrestrial station to the terminal is indicated as A2U, and the link (or channel) from the terminal to the terrestrial station is indicated as U2A. It can be seen that the channel (i.e., A2U channel) from the terrestrial station to the terminal varies with a range from a maximum of about 5.8 bps/Hz to a minimum of about 3.5 bps/Hz according to the distance de between the antennas. In addition, it can be seen that the channel (i.e., U2A channel) from the terminal to the terrestrial station varies with a range from a maximum of about 5.8 bps/Hz to a minimum of about 4 bps/Hz according to the distance de between the antennas. Here, it can be seen that the channel capacity dynamically changes from the maximum value to the minimum value while the distance de between the antenna of the first terminal UT₁ and the antennas of the second terminal UT₂ changes by about 1 m. That is, the MIMO channel capacity varies sensitively to the distance between the antennas. In addition, it may be predicted that the change is repeated with periodicity as the distance between antennas increases due to the characteristics of LoS channel.

In a non-terrestrial network (NTN), an environment similar to that described above may be considered. However, in the NTN, it may be difficult to adjust a distance between antennas in a terminal. Therefore, in the present disclosure, adjusting a distance between antennas in GW(s) of the NTN is considered. In addition, it may be considered that a GW performs transmission through two antennas in a satellite or a GW performs transmission through two satellites located in similar locations.

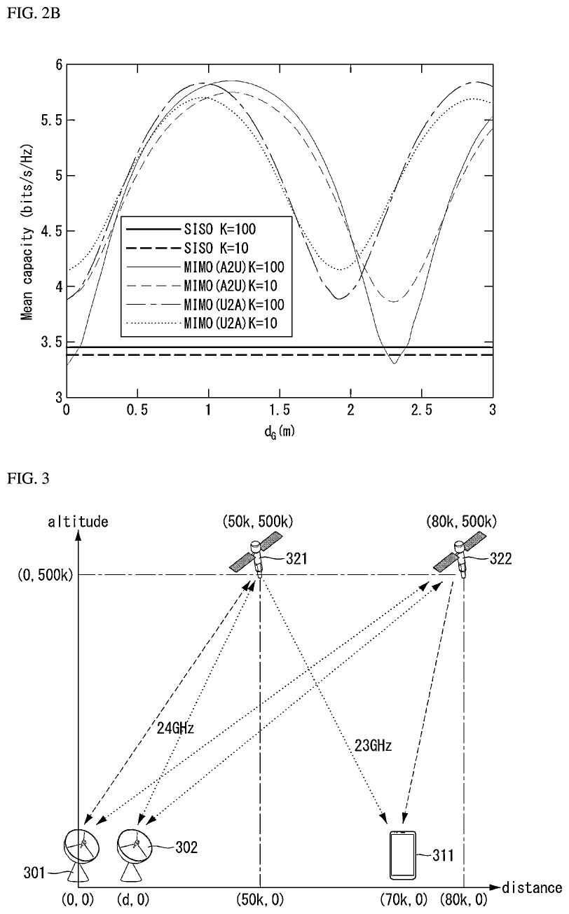

FIG. 3 is an exemplary diagram of an NTN system model with multiple gateways and multiple satellites.

The NTN system model with multiple gateways and multiple satellites, which is illustrated in FIG. 3, may include a first GW 301 and a second GW 302, and may include a first satellite 321 and a second satellite 322.

Based on the first GW 301, a horizontal axis may represent a distance from the first GW 301, and a vertical axis may represent an altitude from the first GW 301, that is, an altitude from the ground (or sea level). Accordingly, since the first GW 301 is used as a reference in FIG. 3, coordinates of the first GW 301 may be (0,0). In addition, since the second GW 302 is located at the same altitude as being separated from the first GW 301 by a distance d, coordinates thereof may be (d, 0). It is assumed that the first satellite 321 and the second satellite 322 are located at an altitude of 500 km above sea level. Accordingly, the first satellite 321 and the second satellite 322 may be located at the same altitude of 500 km.

In the example of FIG. 3, the first satellite 321 is located at a position 50 km away from the first GW 301 at the altitude of 500 km, and the coordinates of the first satellite 321 based on the first GW 301 may be (50 k, 500 k). The second satellite 322 is located at a position 80 km away from the first GW 301 at the altitude of 500 km, and the coordinates of the second satellite 322 based on the first GW 301 may be (80 k, 500 k). Accordingly, the distance between the first satellite 321 and the second satellite 322 may be 30 km. Finally, in FIG. 3, the terminal 311 may be located at a position 70 km away from the first GW 301 at the same altitude, and the coordinates of the terminal 311 based on the first GW 301 may be (70 k, 0).

Meanwhile, as illustrated in FIG. 3, the first GW 301 and the second GW 302 may use a 24 GHz band when communicating with the satellites 321 and 322. In addition, the first satellite 321 and the second satellite 322 may use a 23 GHz band when communicating with the terminal 311.

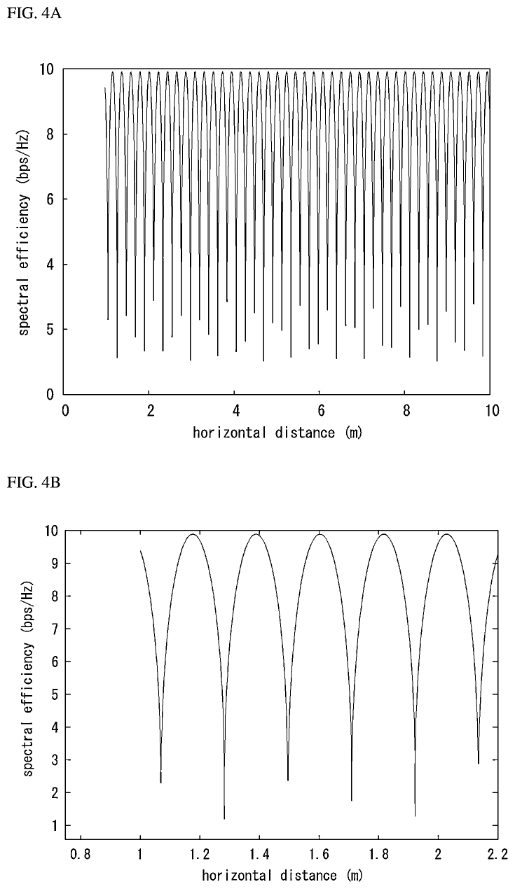

FIGS. 4A and 4B are graphs showing a change in spectral efficiency according to the distance between the GWs when the terminal has one antenna.

Prior to referring to FIGS. 4A and 4B, the following assumptions are made. It is assumed that a difference in reception phases due to a difference in the distances between receive antennas determines channel coefficients, and a magnitude of signals, that is, a power, is inversely proportional to a square of the distance between the transmit antenna and the receive antenna. Therefore, when the distance between the transmit antenna and the receive antenna is D, an element of the channel matrix is \sqrt{D⁻²}e^{j2πf}^{_{c}}^{D}, where f_{c} denotes a carrier frequency.

When the terminal 311 has one antenna, a change in spectral efficiency according to the distance between the first GW 301 and the second GW 302 may be as shown in FIGS. 4A and 4B. FIG. 4A is a graph of a change in spectral efficiency when the distance between the first GW 301 and the second GW 302 is changed up to 10 m, and FIG. 4B is a graph of a change in spectral efficiency when the distance between the first GW 301 and the second GW 302 is changed up to 2.2 m.

As illustrated in FIGS. 4A and 4B, it can be seen that the spectral efficiency varies from 1 bps/Hz to a maximum of 10 bps/Hz according to the change in the distance between the GWs 301 and 302. However, since an overall gain by the channel matrix was normalized in the process of deriving this result, only relative performances, not absolute values, should be compared and confirmed. That is, it can be confirmed through the graphs of FIGS. 4A and 4B that a gain in MIMO channel capacity can be obtained by appropriately adjusting the distance between the GWs 301 and 302.

Only the change in channel capacity was confirmed when the location of the terminal 311 is 70 km away from the first GW 301 as illustrated in FIG. 4A and FIG. 4B. Therefore, it should be confirmed whether such the change is maintained even if the location of the terminal varies.

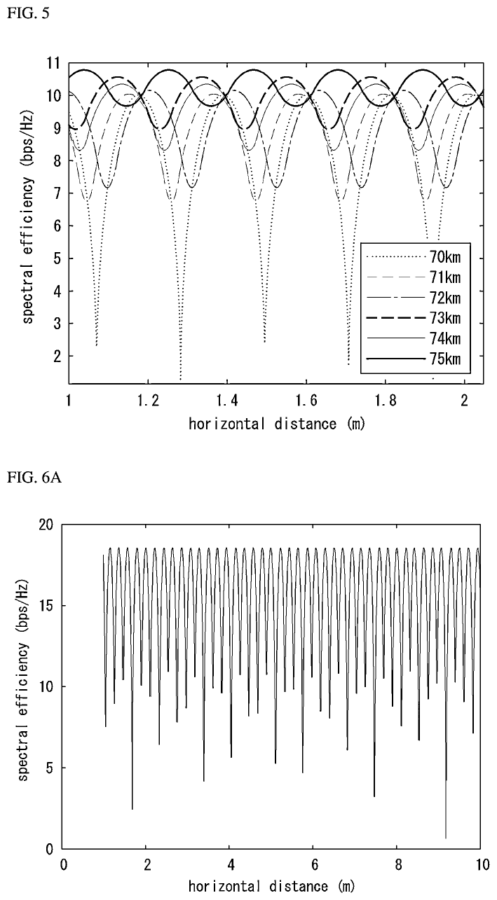

FIG. 5 is a graph of a change in channel capacity according to a change in location of the terminal from the first GW.

Referring to FIG. 5, graphs of a change in channel capacity according to a change in the distance between the GWs 301 and 302 while changing the location of the terminal 311 by 1 km from 70 km to 75 km. Referring to FIG. 5, it can be seen that although the amount of change in channel capacity varies according to the location of the terminal 311, the change in channel capacity exists regardless of the location of the terminal 311. In addition, as can be seen from FIG. 4B, even if the distance between the GWs 301 and 302 changes by only about 10 cm, it can be seen that the amount of change in channel capacity is large. This result may vary depending on a frequency band used, but the relative trend will hold.

On the other hand, the terminal 311 generally has a form including a plurality of antennas. Therefore, the form including a plurality of antennas may be more common than the case where the terminal 311 has only one antenna.

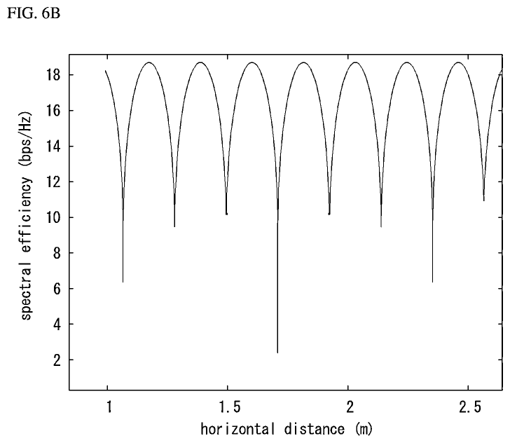

FIGS. 6A and 6B are graphs showing a change in spectral efficiency according to the distance between the GWs when the terminal has two antennas.

Specifically, FIG. 6A is a graph showing a change in spectral efficiency when the terminal has two receiving antennas, a distance between them is 5 cm, and the distance between the first GW 301 and the second GW 302 is up to 10 m, and FIG. 6B is a graph showing a change in spectral efficiency when the terminal has two receiving antennas, a distance between them is 5 cm, and the distance between the first GW 301 and the second GW 302 is up to 2.5 m.

In each graph of FIGS. 6A and 6B, channels from the GWs 301 and 302 to the satellites 321 and 322 are also MIMO channels, and channels from the satellites 321 and 322 to the terminal 311 are also MIMO channels. Each graph of FIGS. 6A and 6B may show spectral efficiency when the distance between the two GWs 301 and 302 is adjusted in the above-described environment.

Referring to FIGS. 6A and 6B, when the terminal has two antennas, the maximum channel capacity may be about 19 bps/Hz. Therefore, comparing the graphs of FIGS. 6A and 6B for the case where the terminal has two antennas and the graphs of FIGS. 4A and 4B for the case where the terminal has one antenna, it can be seen that the overall channel capacity is increased.

In addition, as described above, it can be seen that the channel capacity varies according to the distance between the GWs 301 and 302. Considering a size of a usual directional antenna of the GWs, the change in channel capacity may be made with only a slight distance difference in the almost identical space. Therefore, when a specific GW combination is selected from among several GW candidates having various inter-GW distances, the channel capacity of the NTN system can be maximized.

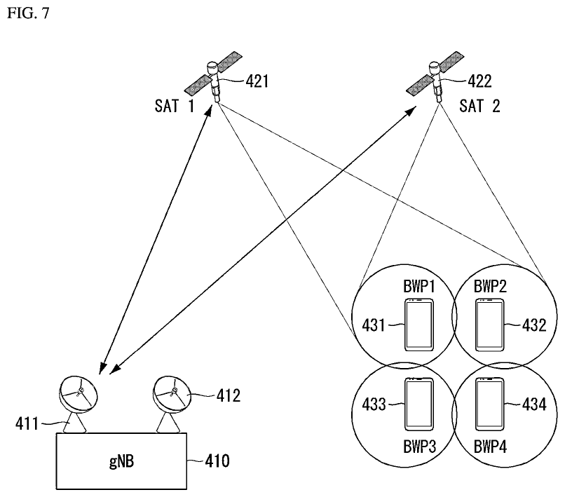

Meanwhile, assuming that the satellite supports multiple beams and a space on the ground to which a given NTN service is provided is designed so that beam footprints of two satellites overlap, it may be expected that the channel capacity will vary greatly depending on selection of satellite beams in addition to the distance between the GWs. In addition, a configuration diagram of the NTN system considering such the situation may take a form of FIG. 7.

FIG. 7 is an exemplary diagram of a configuration of an NTN network supporting multiple GWs, multiple satellites, and multiple beams.

Referring to FIG. 7, a base station gNB 410 may include at least two GWs 411 and 412. The first GW 411 may communicate with a first satellite 421 and a second satellite 422 in an LOS MIMO scheme, and the second GW 412 may also communicate with the first satellite 421 and the second satellite 422 in an LOS MIMO scheme. In addition, the first satellite 421 may transmit downlink data to each of a plurality of terminals 431, 432, 433, and 434 through one LOS beam. In this case, a case in which each of the terminals 431, 432, 433, and 434 included in the NTN network uses a different bandwidth part is exemplified. Specifically, when the first terminal 431 uses a BWP1, the second terminal 432 may use a BWP2, the third terminal 433 may use a BWP3, and the fourth terminal 434 may use a BWP4.

Meanwhile, considering the results described above, when a satellite beam is fixed in the environment with multiple GWs and multiple satellites, in order for one terminal to achieve the maximum channel capacity, an appropriate combination of transmit GWs among the multiple GWs may need to be selected. In addition, a case where multiple beams are used by the satellites may be considered. For example, the first satellite 421 may communicate with the first terminal 431 using the BWP1, the first satellite 421 may communicate with the second terminal 432 using the BWP2, the first satellite 421 may communicate with the third terminal 431 using the BWP3, and the first satellite 421 may communicate with the fourth terminal 434 using the BWP4. That is, an LOS MISO channel may be formed through which the first satellite 421 receives signals from the plurality of GWs 411 and 412 connected to the gNB 401 and transmits the signals to one terminal through a specific beam (or specific band or BWP).

In this case, the first satellite 421 may achieve the maximum channel capacity by simultaneously optimizing the beams (i.e., BWPs) and the GWs. This feature may be equally applied to the second satellite 422. That is, when the satellites 421 and 422 use different beams (i.e., BWPs) for communication with the terminals, channel capacity may be increased through an optimal combination of the beams and the corresponding GWs.

Therefore, the present disclosure proposes a structure of a synchronization signal block (SSB) capable of estimating a multi-antenna channel for measuring MISO or MIMO channel capacity in the process described above to select the optimal combination of GWs and beams. In this case, considering the fact that most of the satellite channels are LOS channels, an efficient SSB transmission structure may be identified.

In the scenario in which multiple GWs exist, GWs connected to a base station (referred to as ‘gNB’ in the following description) may serve as distributed antennas of the gNB. Further, it may be assumed that a set of GWs exists so that the gNB can select and use antenna(s) from the set of GWs according to circumstances. It may also be assumed that antennas of the GWs are physically movable, but considering that it is difficult to establish a stable communication link while the antennas are moving, a structure of selecting antennas(s) from the set of GWs will be first considered.

### [Proposal of SSB Transmission Structure]

In a first scheme, proposed is a two-step SSB combining an optimal beam selection process for selecting which beam is optimal among beams occupying the same BWP and an optimal GW selection process for selecting an optimal GW combination based on the selected beam. The optimal beam selection may be performed first because only signal strengths are simply considered for the optimal beam selection, and then the optimal GW selection may be performed because multi-antenna channel capacity is required for the optimal GW selection.

As an SSB for the optimal beam selection which is the first step, the most of the existing SSB structure of the 5G NR may be utilized. However, in order to enable the multi-antenna channel estimation, an SSB for the optimal GW selection needs modification to the existing SSB structure.

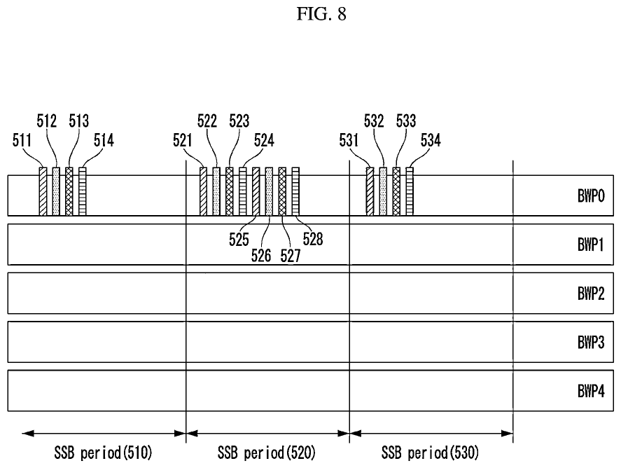

FIG. 8 is an exemplary diagram for describing SSB transmission for an NTN system supporting multiple GWs, multiple satellites, and multiple beams according to the present disclosure.

The SSB transmission illustrated in FIG. 8 is configured for identification of beams and GW combinations when the number of beams supported by the satellite is four and the number of GW combinations is eight. However, the example of FIG. 8 is only for describing an exemplary embodiment of the present disclosure. In addition, in FIG. 8, a description will be made using a form in which signals are received from one satellite. This is for convenience of description, and the SSBs described in FIG. 8 may be received from two or more satellites.

Referring to FIG. 8, five different BWPs (i.e., BWP0, BWP1, BWP2, BWP3, and BWP4) are illustrated. In addition, a case in which SSBs are transmitted in the first bandwidth part BWP0 among the five bandwidth parts (i.e., BWP0, BWP1, BWP2, BWP3, and BWP4) is exemplified. Although the example of FIG. 8 exemplifies the case in which SSBs are transmitted only in the BWP0, this is only for convenience of description and limitations of the drawing, and the SSBs may be transmitted in other BWPs as well. That is, the SSBs may be transmitted in the same manner as the BWP0 in other BWPs, BWP1, BWP2, BWP3, and BWP4.

The gNB may control the satellites to periodically transmit the SSBs, and in FIG. 8, a first SSB period 510, a second SSB period 520, and a third SSB period 530 are illustrated among SSB periods. In addition, in the first SSB period 510, a first SSB 511, a second SSB 512, a third SSB 513, and a fourth SSB 514 may be transmitted. In addition, in the second SSB period 520, a first SSB 521, a second SSB 522, a third SSB 523, a fourth SSB 524, a fifth SSB 525, a sixth SSB 526, a seventh SSB 527, and an eighth SSB 528 may be transmitted. In the third SSB period 530, a first SSB 531, a second SSB 532, a third SSB 533, and a fourth SSB 534 may be transmitted.

In this case, the first SSB 511, the second SSB 512, the third SSB 513, and the fourth SSB 514, which are transmitted in the first SSB period 510, may be SSBs for selecting the best satellite beam. Specifically, in the first SSB period 510, the first SSB 511 may be an SSB transmitted through the first beam among four beams, the second SSB 512 may be an SSB transmitted through the second beam among the four beams, the third SSB 513 may be an SSB transmitted through the third beam among the four beams, and the fourth SSB 514 may be an SSB transmitted through the fourth beam among the four beams. Accordingly, the terminal may select the best satellite beam by measuring signal strengths of SSBs respectively received through the multiple beams.

In addition, the SSBs 521 to 528 transmitted in the second SSB period 520 may be SSBs for selecting the best GW combination. Therefore, each of the SSBs 521 to 528 transmitted in the second SSB period 520 need to be multiplexed with as many SSBs as the number of GWs used for one GW combination. Accordingly, the SSBs transmitted in the second SSB period 520 illustrated in FIG. 8 may be SSBs respectively transmitted by the GWs. That is, the SSBs transmitted in the second SSB period 520 may be SSBs respectively transmitted by the eight GWs.

As a specific example, the first SSB 521 transmitted in the second SSB period 520 is an SSB based on one specific combination, for example, a combination of GW1 and GW2, the second SSB 522 may be an SSB based on another specific combination, for example, a combination of GW2 and GW3, and the third SSB 523 may be an SSB based on another combination, for example, a combination of GW1 and GW3. As such, combinations on which the fourth SSB 524, the fifth SSB 525, the sixth SSB 526, the seventh SSB 527, and the eighth SSB 528 are based may be various combinations of the GWs.

Meanwhile, SSBs transmitted from the respective GWs may need to be transmitted according to the combination. For example, if the number of GWs used for one GW combination is two, the SSB should be transmitted by GWs constituting one GW combination. In the case of selecting two GWs among eight GWs as one combination, a form in which the two GWs transmit the SSB will be described.

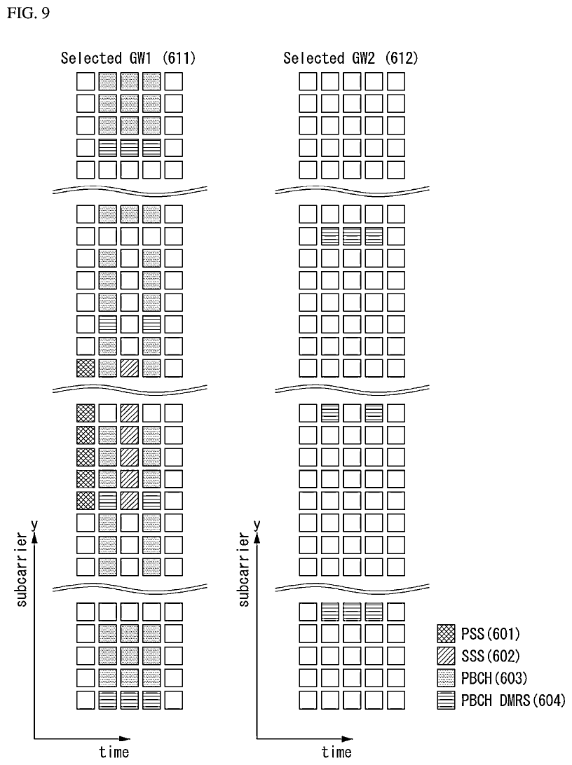

FIG. 9 is an exemplary diagram illustrating a structure of an SSB transmitted from each GW when there are two selected GWs according to an exemplary embodiment of the present disclosure.

In FIG. 9, it is assumed that the GW1 and the GW2 are selected among the eight GWs described above with reference to FIG. 8. Therefore, in FIG. 9, it is assumed that the SSB are transmitted from the selected GW1 611 and the selected GW2 612.

Referring to FIG. 9, the selected GW1 611 may transmit a primary synchronization signal (PSS) 601, a secondary synchronization signal (SSS) 602, and a physical broadcast channel (PBCH) 603. In addition, the selected GW1 611 may be configured to transmit a part of a PBCH demodulation reference signal (DMRS) 604. In addition, the selected GW2 612 may transmit only the remaining part of the PBCH DMRS 604.

As illustrated in FIG. 9, the selected GW1 611 may transmit a part of subcarriers of the PBCH-DMRS of the SSB, and the selected GW2 612 may transmit the remaining subcarriers of the PBCH-DMRS of the SSB. Accordingly, the satellite receiving the signals transmitted by the GW1 611 and the GW2 612 may multiplex them and transmit them to the terminal. Through this, the signal for selection of optimal GW combination transmitted from the satellite may enable multi-antenna channel estimation while maintaining the overall structure of the SSB defined in the 5G NR specification.

When the signals transmitted by the GW1 611 and GW2 612 are transmitted as being configured differently from each other as illustrated in FIG. 9, the terminal may perform initial synchronization and the like through the PSS 601 and SSS 602 transmitted by the GW1 611. In addition, the terminal may use the part of the PBCH-DMRS transmitted from the GW1 611 to demodulate the PBCH. Since only the remaining part of the PBCH-DMRS is transmitted by the GW2 612, this may be used only for channel estimation. Therefore, the terminal may perform channel estimation for the combination of the GW1 611 and the GW2 612 using channel information estimated during the PBCH demodulation process and channel estimation information using the PBCH-DMRS of the GW2 612. The channel estimation result may be transmitted from the terminal to the base station, and the base station may calculate antenna channel capacity using the channel estimation information.

In addition, when the terminal can calculate the antenna channel capacity using the channel estimation information, the terminal may transmit information on the antenna channel capacity to the base station (i.e., gNB).

In addition, a modified form of the method illustrated in FIG. 9 may also be possible. In the example of FIG. 9, only the PBCH DMRS 604 is transmitted by the two GWs 611 and 612 as being divided, but the PBCH may also be transmitted as being divided. That is, the two GWs 611 and 612 may be configured to divide and transmit the PBCH. When PBCH is transmitted as being divided in this manner, the PBCH DMRS may be configured as illustrated in FIG. 9 or the PBCH DMRS may be configured in a different form.

As another form, two PBCH DMRSs 604 respectively transmitted by the GWs 611 and 612 in the frequency domain may be transmitted as being multiplied by orthogonal Walsh codes. Specifically, the two GWs 611 and 612 may transmit the PBCH DMRSs located in adjacent subcarriers by multiplying a code [1 1] and a code [1 −1] thereto, respectively. In the orthogonal codes, ‘1’ means that the existing PBCH DMRS 604 is transmitted as it is, and ‘−1’ means that the sign of the existing PBCH DMRS 604 is transmitted as being inversed. Accordingly, the receiving end, that is, the terminal, may estimate the channel from the GW1 611 by adding the PBCH DMRS 604s received at two adjacent subcarriers, and demodulate the PBCH. In addition, the terminal may estimate the channel from the GW2 612 by subtracting the PBCH DMRSs 604 received at the two adjacent subcarriers from each other.

When using the transmission scheme of two PBCH DMRSs based on orthogonal Walsh codes, accuracy of the channel actually used for PBCH demodulation may be deteriorated. However, in the satellite environment where the LOS channel environment is guaranteed, the difference in channel accuracy deterioration may be insignificant.

Meanwhile, as another approach for multi-antenna channel estimation, a scheme in which SSBs are simultaneously transmitted in different frequency bands while maintaining the existing structure of SSBs may be considered.

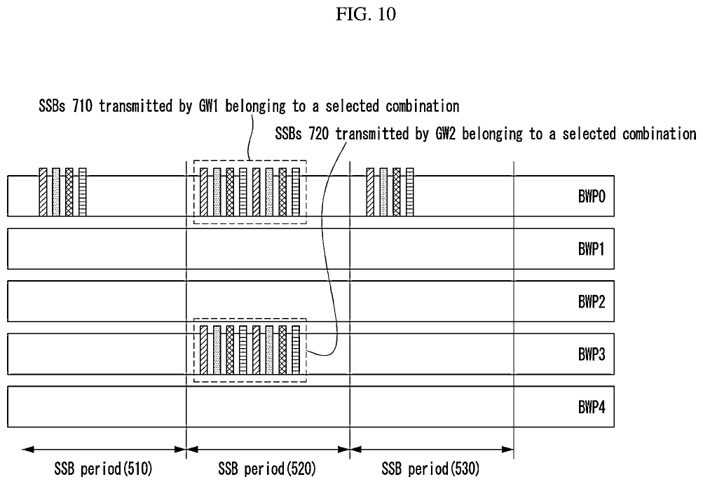

FIG. 10 is an exemplary diagram for describing SSB transmission for an NTN system supporting multiple GWs, multiple satellites, and multiple beam bandwidths according to another embodiment exemplary of the present disclosure.

Referring to FIG. 10, as described in FIG. 8, five different BWPs (i.e., BWP0, BWP1, BWP2, BWP3, and BWP4) are exemplified. In addition, as in FIG. 8, the first SSB period 510, the second SSB period 520, and the third SSB period 530 are illustrated. For each period, the reference numerals described in FIG. 8 were used as they are.

In addition, as described with reference to FIG. 8, the first SSB, the second SSB, the third SSB, and the fourth SSB may be transmitted in the first SSB period 510. In the second SSB period 520, the first SSB to the eighth SSB may be transmitted as illustrated. Therefore, as described with reference to FIG. 8, SSBs corresponding to four different beams may be transmitted in the first SSB period 510, so that a procedure for finding out an optimal beam is performed.

When compared with FIG. 8, FIG. 10 illustrates a form in which eight SSBs are transmitted in each of the first BWP (i.e., BWP0) and the fourth BWP (i.e., BWP3) in the second SSB period 520. This may correspond to a case where SSBs for selection of a GW combination are transmitted in the two BWPs (i.e., BWP0 and BWP3). Specifically, as described above, in the first SSB period 510, the BWP0 may be the optimal BWP for the GW1, the BWP3 may be the optimal BWP for the GW2, and the optimal beam among four beams for each of the GW1 and GW2 may be determined. Accordingly, SSBs 710 transmitted through the BWP0 in the second SSB period 520 may be SSBs transmitted by the GW1 in a specific selected combination, and SSBs 720 transmitted through the BWP3 in the second SSB period 520 may be SSBs transmitted by the GW2 in the specific selected combination. Therefore, the satellite may transmit SSBs corresponding to the GW1 in the second SSB period 520 to the terminal through the BWP0 using the beam selected in the first SSB period 510. In addition, the satellite may transmit SSBs corresponding to the GW2 in the second SSB period 520 to the terminal through the BWP3 using the beam selected in the first SSB period 510.

FIG. 10 shows an example of the case where the GWs can use different BWPs, and other types of combinations are also possible. For example, the satellite may transmit the SSBs corresponding to the GW1 through the BWP1 and transmit the SSBs corresponding to the GW2 through the BWP0. As another example, the satellite may transmit the SSBs corresponding to the GW1 through the BWP4 and transmit the SSBs corresponding to the GW2 through the BWP1. As such, various modified forms may be possible.

In addition, considering the LOS channel environment of the satellite also in the scheme illustrated in FIG. 10, the assumption is made that the channel in the BWP0 and the channel in the BWP3 are the same. Therefore, this case may correspond to a case where the multi-antenna channel estimation can be performed while maintaining the existing SSB structure of 5G NR as much as possible.

The operation of the satellite described above may be controlled by the gNB 410 described in FIG. 6. As another example, the operation of the satellite described above may be controlled by the satellite itself. In addition, in the descriptions of FIGS. 8 and 10, a procedure for reporting a result of the channel estimation by the receiving end, that is, the terminal, has been omitted or briefly described. This is because the procedure for reporting the channel estimation result is already widely known.

Looking at the procedures according to FIGS. 8 and 10 as a whole again, the following description will be made. The description will be made using the configuration of FIG. 7, and it is assumed that there are two or more GWs. Although only two GWs 412 and 413 are illustrated in FIG. 7, three or more GWs may be included.

The gNB 410 may control the SSBs that the satellite transmits to be transmitted in the first SSB period 510. In this case, as described above, when each satellite can form four different beams, the gNB 410 may control each satellite to transmit the SSBs through four beams. That is, the gNB 410 may control the SSBs transmitted in the first SSB period 510 described in FIG. 8 to be transmitted from the satellite.

In addition, when the satellite can use the bandwidth parts BWP0 to BWP4 as illustrated in FIGS. 8 and 10, the gNB 410 may control the SSBs to be transmitted in the first SSB period 410 through four different beams in each of the bandwidth parts (i.e., BWP0, BWP1, BWP2, BWP3, and BWP4). In addition, as illustrated in FIG. 7, when there are two or more satellites, the gNB 410 may control each satellite to perform the same operation.

The terminal may select an optimal satellite beam and an optimal BWP based on the beams transmitted by each satellite through the different BWPs (i.e., BWP0, BWP1, BWP2, BWP3, and BWP4). As described above, the optimal satellite beam and BWP may be determined based on signal strengths of the SSBs transmitted through the respective BWPs. In addition, the terminal may report information on the optimal satellite beam and BWP to the gNB 410 as a measurement report.

Thereafter, the gNB 410 may determine a BWP and a transmission beam to be provided to the corresponding terminal based on the information included in the measurement report of the terminal. In addition, the gNB 410 may transmit SSBs for selecting a GW combination in the second SSB period to determine the GW combination. A method of configuring the SSBs for each combination consisting of two GWs may be implemented according to the example of FIG. 9 and the description thereof and descriptions of the modified examples. In addition, the SSBs may be configured based on a combination of three or more GWs using the method described in the present disclosure.

The gNB 410 that has generated SSBs to be transmitted in the second SSB period 520 according to one of the methods according to the present disclosure may transmit them to the satellites 421 and 422 through the corresponding GWs. Accordingly, as described in FIG. 8 or FIG. 10, each of the satellites 421 and 422 may transmit the SSBs corresponding to the GW combination in the second SSB period 520.

Each of the satellites 421 and 422 receiving the signals from the GWs as shown in FIG. 9 may multiplex the signals to generate one SSB signal. Each of the satellites 421 and 422 may finally generate SSB signals for the eight combinations as described in FIGS. 8 and 10.

The terminal may receive the signals based on the respective GW combinations and report a measurement report corresponding thereto to the gNB 410. In this case, the measurement report may report only information on an SSB having the largest received signal strength or may report measured signal strength information of all SSBs.

The gNB 401 may determine an optimal GW combination based on the measurement report received from the terminal. The optimal GW combination may be determined to maximize the channel capacity by considering the measurement report, the distance between GWs, and the distance between the terminal and a reference GW.

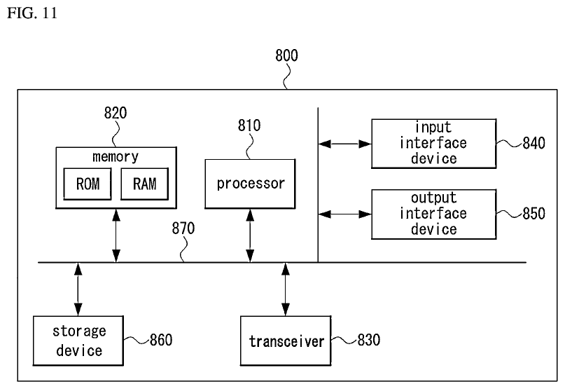

FIG. 11 is a block diagram illustrating an exemplary embodiment of a communication node.

Referring to FIG. 11, a communication node 800 may comprise at least one processor 810, a memory 820, and a transceiver 830 connected to the network for performing communications. Also, the communication node 800 may further comprise an input interface device 840, an output interface device 850, a storage device 860, and the like. Each component included in the communication node 800 may communicate with each other as connected through a bus 870.

However, each component included in the communication node 800 may be connected to the processor 810 via an individual interface or a separate bus, rather than the common bus 870. For example, the processor 810 may be connected to at least one of the memory 820, the transceiver 830, the input interface device 840, the output interface device 850, and the storage device 860 via a dedicated interface.

The processor 810 may execute a program stored in at least one of the memory 820 and the storage device 860. The processor 810 may refer to a central processing unit (CPU), a graphics processing unit (GPU), or a dedicated processor on which methods in accordance with exemplary embodiments of the present invention are performed. Each of the memory 820 and the storage device 860 may be constituted by at least one of a volatile storage medium and a non-volatile storage medium. For example, the memory 820 may comprise at least one of read-only memory (ROM) and random access memory (RAM).

The communication node 800 described above may be at least one of the terminals 431, 432, 433, and 434 described in FIG. 7. If the communication node 800 is the terminal, the processor 810 may control the terminal to perform the operations described above.

In addition, the communication node 800 may be the gNB 410 described in FIG. 7. If the communication node 800 is the gNB 410, the transceiver 830 may have a configuration for connecting to two or more GWs or may include two or more GWs. Further, when the communication node 800 is the gNB 410, the processor 810 may control the gNB 410 to perform the operations described above.

In addition, the communication node 800 may be the satellite. If the communication node 800 is one of the satellites 421 and 422, the transceiver 830 may receive signals from the GWs and transmit them to the terminals as described in the present disclosure. Further, when the communication node 800 is the satellite, the processor 810 may control the satellite to perform the operations described above.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

1. A method for a base station connectable to a plurality of gateways to transmit synchronization signal blocks (SSBs) through a plurality of satellites, the method comprising:
controlling first SSBs corresponding to a number of beams of each of the satellites to be transmitted through respective transmission beams in a first SSB period;
determining a transmission beam of each of the satellites based on a first measurement report for the respective transmission beams, the first measurement report being received from a terminal;
controlling second SSBs for determining one combination among combinations each including two or more gateways among the plurality of gateways to be transmitted in a second SSB period; and
determining a first combination including two or more gateways based on a second measurement report for the second SSBs, the second measurement report being received from the terminal,
wherein the number of the second SSBs is determined according to a number of the combinations of the gateways.

2. The method according to claim 1, wherein the first SSBs are transmitted through all bandwidth parts (BWPs) of the satellites.

3. The method according to claim 2, wherein one BWP is determined when determining the transmission beam of each of the satellites.

4. The method according to claim 2, wherein the first measurement report includes information on received signal strength(s) for at least one beam in at least one BWP.

5. The method according to claim 1, wherein each of the second SSBs is generated based on a combination of at least two gateways.

6. The method according to claim 1, further comprising, when each of the second SSBs is generated based on a combination of a first gateway and a second gateway,
controlling the first gateway to transmit a first gateway SSB signal to the terminal through the plurality of satellites, the first gateway SSB signal including a primary synchronization signal (PSS), a secondary synchronization signal (SSS), a physical broadcast channel (PBCH), and at least part of a PBCH demodulation reference signal (DMRS) for demodulation of the PBCH; and
controlling the second gateway to transmit a second gateway SSB signal to the terminal through the plurality of satellites, the second gateway SSB signal including a remaining part of the PBCH DMRS for demodulation of the PBCH.

7. The method according to claim 6, wherein the second measurement report includes channel estimation information for the first gateway and channel estimation information for the second gateway.

8. The method according to claim 6, wherein the at least part of the PBCH DMRS included in the first gateway SSB signal is transmitted as being multiplied with an orthogonal Walsh code [1 1], and the remaining part of the PBCH DMRS included in the second gateway SSB signal is transmitted as being multiplied with an orthogonal Walsh code [1 −1].

9. The method according to claim 1, wherein when determining the first combination, a combination having a largest antenna channel capacity is determined as the first combination based on the received second measurement report.

10. A base station apparatus comprising:
a processor; and
a transceiver configured to transmit or receive signals to or from a plurality of satellites through a plurality of gateways,
wherein the processor is configured to:
control first SSBs corresponding to a number of beams of each of the satellites to be transmitted through respective transmission beams in a first SSB period;
determine a transmission beam of each of the satellites based on a first measurement report for the respective transmission beams, the first measurement report being received from a terminal;
control second SSBs for determining one combination including two or more gateways among the plurality of gateways to be transmitted in a second SSB period; and
determine a first combination including two or more gateways based on a second measurement report for the second SSBs, the second measurement report being received from the terminal,
wherein the number of the second SSBs is determined according to a number of combinations of the gateways.

11. The base station apparatus according to claim 10, wherein the processor is further configured to control the first SSBs to be transmitted through all bandwidth parts (BWPs) of the satellites.

12. The base station apparatus according to claim 11, wherein the processor is further configured to determine one BWP when determining the transmission beam of each of the satellites.

13. The base station apparatus according to claim 11, wherein the first measurement report includes information on received signal strength(s) for at least one beam in at least one BWP.

14. The base station apparatus according to claim 10, wherein each of the second SSBs is generated based on a combination of at least two gateways.

15. The base station apparatus according to claim 10, wherein when each of the second SSBs is generated based on a combination of a first gateway and a second gateway, the processor is further configured to:
control the first gateway to transmit a first gateway SSB signal to the terminal through the plurality of satellites, the first gateway SSB signal including a primary synchronization signal (PSS), a secondary synchronization signal (SSS), a physical broadcast channel (PBCH), and at least part of a PBCH demodulation reference signal (DMRS) for demodulation of the PBCH; and
control the second gateway to transmit a second gateway SSB signal to the terminal through the plurality of satellites, the second gateway SSB signal including a remaining part of the PBCH DMRS for demodulation of the PBCH.

16. The base station apparatus according to claim 15, wherein the second measurement report includes channel estimation information for the first gateway and channel estimation information for the second gateway.

17. The base station apparatus according to claim 15, wherein the processor is further configured to transmit the at least part of the PBCH DMRS included in the first gateway SSB signal as being multiplied with an orthogonal Walsh code [1 1], and transmit the remaining part of the PBCH DMRS included in the second gateway SSB signal as being multiplied with an orthogonal Walsh code [1 −1].

18. The base station apparatus according to claim 10, wherein when determining the first combination, the processor is further configured to determine a combination having a largest antenna channel capacity as the first combination based on the received second measurement report.

19. A method for a base station in a non-terrestrial network (NTN) to configure synchronization signal blocks (SSBs), the method comprising:
generating first SSBs corresponding to a number of beams of each of satellites in a first SSB period; and
generating second SSBs for determining one combination among combinations each including two gateways among a plurality of gateways in a second SSB period,
wherein a number of the second SSBs is determined according to a number of the combinations of the gateways.

20. The method according to claim 19, wherein each of the second SSBs is configured to include a primary synchronization signal (PSS), a secondary synchronization signal (SSS), a physical broadcast channel (PBCH), and at least part of a PBCH demodulation reference signal (DMRS) for demodulation of the PBCH, which are transmitted from one gateway included in the combinations, and include a remaining part of the PBCH DMRS for demodulation of the PBCH, which is transmitted from another gateway included in the combinations.
